(19) United States
(12) Patent Application Publication
(10) Pub. No.: US 2005/0151917 A1
(43) Pub. Date: Jul. 14, 2005

(54) Display device and fabrication method thereof

(76) Inventor: Wei-Chou Chen, Hsinchu City (TW)

Correspondence Address: RABIN & Berdo, PC, 1101 14TH STREET, NW, SUITE 500, WASHINGTON, DC, 20005, US

(21) Appl. No.: 10/834,256

(22) Filed: Apr. 29, 2004

(30) Foreign Application Priority Data
Jan. 14, 2004 (TW) 93100872

(51) Int. Cl. G02F 1/1343

(52) U.S. Cl. 349/144

(57) ABSTRACT

A display device and the fabrication method thereof. The display device includes a pair of substrates with a gap therebetween, respectively having counter electrodes thereon, a seal pattern disposed between the substrates, surrounding the periphery of a display area for joining the substrates, a blocking disposed between the substrates for separating the display area into at least two sub-display areas, and a display medium disposed on the sub-display areas.

### BACKGROUND OF THE INVENTION

1. Field of the invention

The present invention relates to a display device and a fabrication method thereof, and more particularly to a display device and a fabrication thereof with improved large-scale display performance.

2. Description of the Related Art

Liquid crystal displays (LCDs) are a common flat panel display technology. Owing to dielectric anisotropy and optical anisotropy of liquid crystal molecules, molecular orientation of liquid crystals can be shifted under an external electrical field, such that various optical effects are produced.

An LCD panel is generally made up of two substrates, with a certain gap preserved therebetween, and a liquid crystal layer filled in the gap. Respective electrodes are formed on the two substrates, respectively, to control the orientation and shift of liquid crystal molecules.

Currently, as flat panel technology aims to achieve large-scale displays, LCDs have encountered a number of technical problems, one of which is the “gravitational mura” caused by gravity.

An LCD must be vertically positioned during operation, and the display medium of the LCD, liquid crystal molecules, inevitably suffers from gravity, inducing the molecules to move downward. For a large-size LCD, a 50″ LCD for example, the liquid crystal molecules suffer from higher gravity, pulling the liquid crystal molecules downward, deteriorating display performance, and even bursting the panel cell by liquid crystal molecules of the display extruding the lower portion.

### SUMMARY OF THE INVENTION

Accordingly, an object of the present invention is to provide a display device and fabrication method thereof to ameliorate the display flaws caused by gravity and to improve display performance of large-size display devices.

To achieve the above object, a blocking is disposed on a display area of the display device, separating the display area into at least two sub-display areas, an upper sub-display area and a lower sub-display area, together with dividing the display medium into an upper and a lower part respectively on the upper sub-display area and the lower sub-display area. Thus, display performance can be protected from “gravitational mura” caused by gravity.

Therefore, the invention provides a display device, which comprises a pair of substrates with a gap therebetween, respectively having counter electrodes thereon, a seal pattern disposed between the substrates, surrounding the periphery of a display area for joining the substrates, a blocking disposed between the substrates for separating the display area into at least two sub-display areas, and a display medium disposed on the sub-display areas.

The invention further provides a fabrication method for a display device, which comprises providing a pair of substrates respectively with a counter electrode thereon, disposing a seal pattern on the periphery of at least one substrate to surround a display area, disposing a blocking on at least one substrate, and joining the substrates with a gap formed therebetween by the seal pattern, and disposing a display medium between the substrates, wherein the blocking separates the display area into at least two sub-display areas, each with the display medium thereon.

In the invention, the blocking may comprise a sealing material for joining the substrates, and may also comprise a spacer or photospacer.

The seal pattern can comprise a UV curable resin, and can also comprise a spacer. The blocking and the seal pattern are preferably of the same sealing material for joining the substrates.

The substrates are, for example, glass or polymeric substrates, and may comprise a color filter and an active matrix array formed thereon. The color filter and the active matrix array can be respectively disposed on each of the substrates, or can be disposed as color-filter-on-array on one of the substrates.

The blocking can be disposed corresponding to the active matrix array, and is preferably disposed perpendicular to the gravitational direction.

In the invention, the display medium can be liquid crystal or polymer gel.

### DESCRIPTION OF THE DRAWINGS

The present invention can be more fully understood by reading the subsequent detailed description and examples with references made to the accompanying drawings, wherein:

FIG. 1 is a top view showing a TFT array substrate of the embodiment;

FIG. 2 illustrates the fabrication of a color filter substrate of the embodiment;

FIG. 3 illustrates a layout of a blocking of the embodiment;

FIG. 4 is a cross-section of an LCD of the embodiment;

FIG. 5 is a cross-section of the LCD taken along the blocking of the embodiment; and

FIG. 6 is a cross-section of an LCD taken along the blocking of another embodiment.

### DETAILED DESCRIPTION OF THE INVENTION

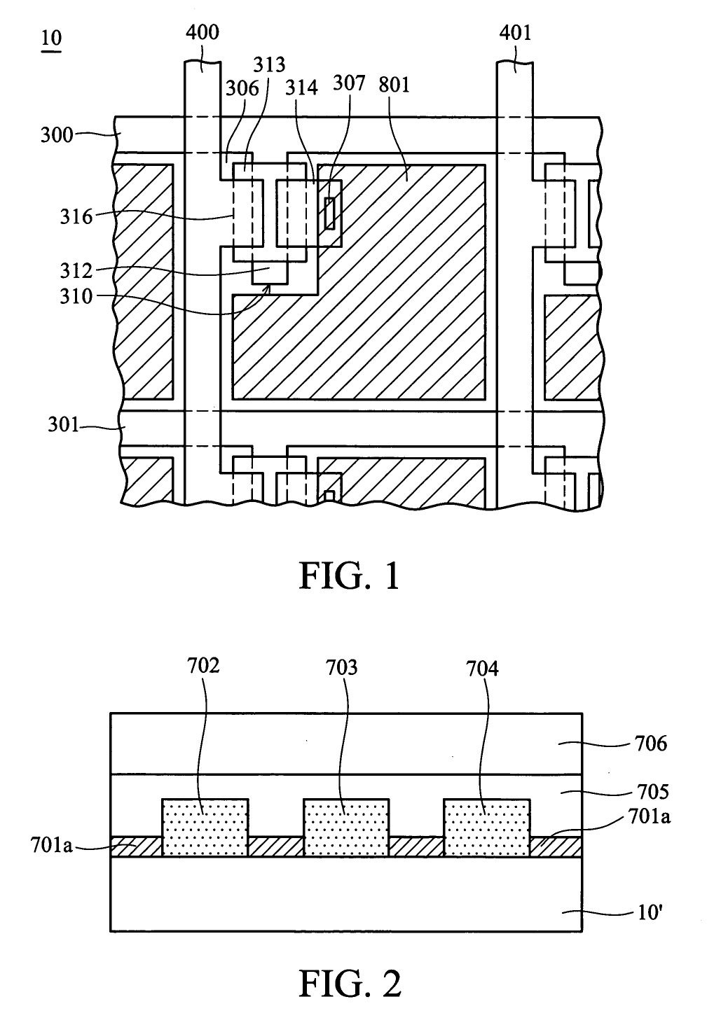

FIGS. 1-6 are used, with the embodiment, to explain the inventive display device and the fabrication method thereof, in which a thin-film transistor LCD (TFT LCD) is given as an example of the inventive display device.

The TFT LCD comprises a TFT array substrate and a color filter substrate, fabrication of each is respectively described in the following.

Manufacture of TFT Array Substrate

FIG. 1 is a top view of the TFT array substrate of the embodiment.

First, as in FIG. 1, a substrate 10 of, for example, glass or transparent polymers, is provided. As a polymeric substrate, the substrate 10 can be a substrate of polyethyleneterephthalates, polyesters, polycarbonates, polyacrylates or polystyrenes. Next, gate lines 300, 301 and a gate electrode 312 are formed thereon. A gate insulating layer (not shown) is then formed on the substrate 10. The gate lines 300, 301 and gate electrode 312 comprise, for example, metal. The gate insulating layer comprises, for example, SiO₂, SiNₓ, or silicon oxynitride.

An a-Si layer (below a n⁺ α-Si layer 313, not shown) and the n⁺ α-Si layer 313 are then formed on part of the gate insulating layer to form an a-Si semiconductor island on a TFT area 310.

Then, signal lines 400, 401, a source electrode 316 and a drain electrode 314 are formed, wherein the source electrode 316 is electrically connected to the signal line 400.

Then, a transparent photoresist (not shown) is formed conformally on the substrate 10, followed by a photolithography step whereby a contact hole 307 above the drain electrode 314 is formed to expose part of the surface of the drain electrode 314.

Finally, a pixel electrode 801, electrically connected to the drain electrode 314 via the contact hole 307, is formed on a pixel area 306. The pixel electrode 801 may be a layer of indium tin oxide (ITO), indium zinc oxide (IZO), aluminum zinc oxide (AZO) or zinc oxide (ZnO), formed by sputtering, electron-beam evaporation deposition, thermal evaporation deposition, chemical vapor deposition or spray pyrolysis.

Manufacture of Color Filter Substrate

Currently, numerous methods are employed to fabricate color filters, including pigment dispersion, dyeing, electrodeposition, and printing. Of the invention, pigment dispersion is utilized to illustrate the manufacture of the color filter substrate.

FIG. 2 illustrates the fabrication of a color filter substrate of the embodiment. A substrate 10′ of glass or transparent polymers is provided with a light shielding pattern 701a of, for example, Cr or black photo-sensitive resin formed thereon. The light shielding pattern 701a, also referred to as a black matrix, shields light and separates color-filter resins of different colors to enhance color contrast.

Next, color-filtering units of red, green and blue are sequentially formed. For example, red resin is first spin-coated over the substrate 10′ to form a red color-filtering layer 702. Then, photolithography is performed to leave only the red resin in the predetermined area.

In the same manner, blue and green resin are sequentially spin-coated over the substrate 10′, and blue color-filtering units 703 and green color-filtering units 704 remain in the respective predetermined sub-pixel areas.

Next, a transparent planarization layer 705 is then formed on the substrate 10′, and an electrode layer 706 of, for example, transparent conductive material, e.g. ITO or IZO, is formed on the planarization layer 705 to drive the molecular orientation of liquid crystals.

Cell Process

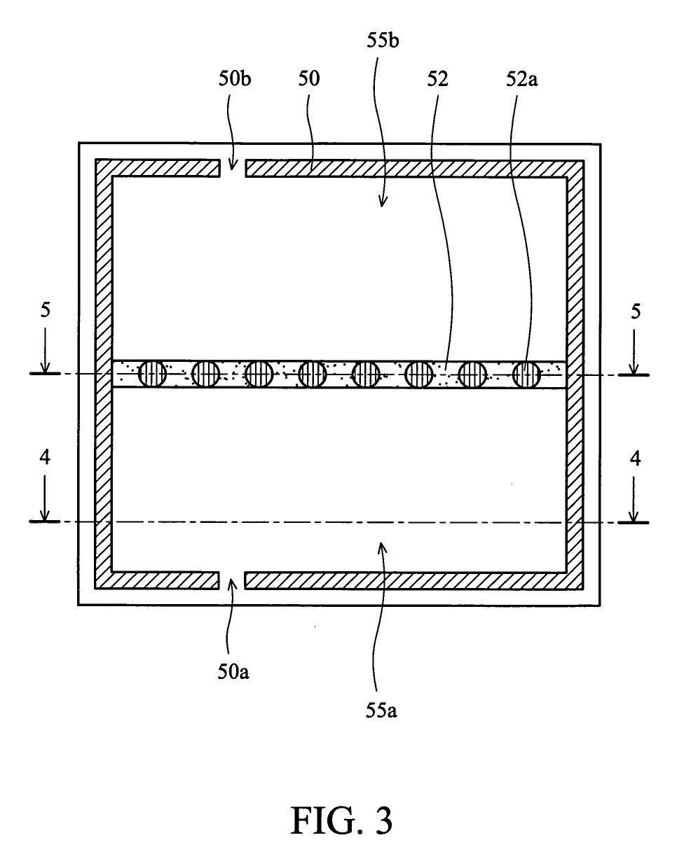

In FIG. 3, a seal pattern 50 of sealant is formed on the TFT array substrate 10 and/or the color filter substrate 10′ for joining the two substrates. The seal pattern 50 of, for example, UV curable resin, is provided with two openings 50a, 50b for liquid crystal injection.

Meanwhile, a key feature of the invention is performed. A blocking 52 is disposed on the TFT array substrate 10, corresponding to a gate line (not shown) of the TFT array, separating a display area surrounded by the seal pattern 50 into two independent sub-display areas 55a, 55b. In the embodiment, the blocking 52 comprises the same material as the seal pattern 50, further comprising spherical spacers 52a of a uniform diameter for supporting the substrates 10, 10′ in addition to joining them.

Next, in a normal LCD panel fabrication process, the color filter substrate 10′ and TFT array substrate 10 are aligned and combined, such that each pixel area 306 corresponds to a color filtering unit 702, 703, or 704.

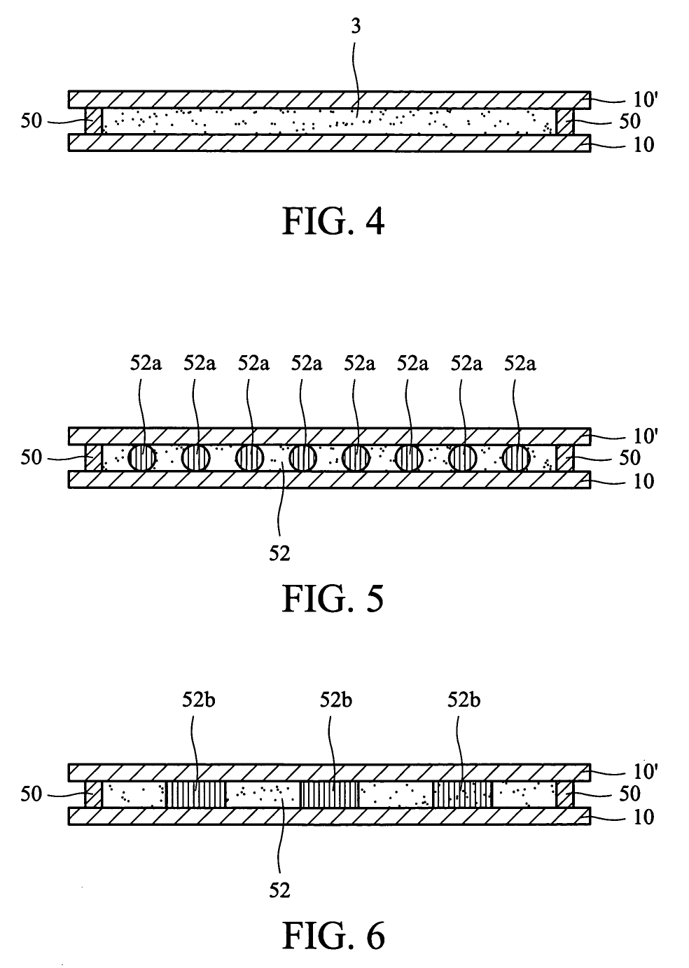

Subsequentially, liquid crystal 3 is filled into the respective sub-display areas 55a, 55b of the LCD panel via the openings 50a, 50b, following sealing of the panel. FIG. 4 is a cross-section of the LCD panel, and FIG. 5 is a cross-section of the LCD panel taken along the blocking 52.

In the embodiment, the blocking 52 is disposed corresponding to the gate line 300, 301. The blocking 52 can also be disposed corresponding to the signal lines 400, 401. According to the invention, the blocking 52 is preferably disposed perpendicular to the gravitational direction during operation to serve as a blocking for falling liquid crystal molecules.

In the embodiment, the blocking 52 is disposed on the TFT array substrate 10. The blocking 52 can also be disposed on the color filter substrate 10′, corresponding to the light shielding pattern 701a, and performs the same function.

In the embodiment, the blocking 52 comprises the same material as the seal pattern 50 (UV curable resin), with spacers 52a for supporting the substrates 10, 10′. According to the invention, the blocking 52 may also comprise photospacers 52b of photoresist covered with a thin film of sealing material for performing supporting and joining functions, as shown in FIG. 6.

Furthermore, only one blocking 52 is disposed in the embodiment, but the quantity may be increased.

Accordingly, the display device comprises a pair of substrates 10, 10′ with a gap therebetween and counter electrodes 801, 706 respectively disposed thereon. A seal pattern 50 is disposed between the substrates 10, 10′, surrounding a display area, for joining the substrates 10, 10′. A blocking 52 disposed between the substrates 10, 10′ separates the display area into two independent sub-display areas 55a, 55b, each with liquid crystals 3 thereon.

According to the inventive display device and the fabrication method thereof, by disposing the blocking 52 on the display area of the display device to divide the liquid crystals 3 into a lower and an upper part, display performance is protected from “gravitational mura” caused by gravity. The display flaws caused by gravity are thereby ameliorated, and display performance of large-size display devices is improved.

The foregoing description has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

1. A display device, comprising:
a pair of substrates with a gap therebetween, respectively having counter electrodes thereon;
a seal pattern disposed between the substrates, surrounding the periphery of a display area for joining the substrates;
a blocking disposed between the substrates for separating the display area into at least two sub-display areas; and
a display medium disposed on the sub-display areas.

2. The display device as claimed in claim 1, wherein the blocking comprises a sealing material for joining the substrates.

3. The display device as claimed in claim 1, wherein the blocking comprises a spacer or photospacer.

4. The display device as claimed in claim 1, wherein the seal pattern comprises a UV curable resin.

5. The display device as claimed in claim 1, wherein the seal pattern comprises a spacer.

6. The display device as claimed in claim 1, wherein the blocking and the seal pattern are of the same sealing material for joining the substrates.

7. The display device as claimed in claim 1, wherein the substrates are glass or polymeric substrates.

8. The display device as claimed in claim 1, wherein a color filter and an active matrix array are formed on the substrates.

9. The display device as claimed in claim 8, wherein the active matrix comprises a plurality of gate lines and signal lines, and the blocking is disposed corresponding to the gate lines or the signal lines.

10. The display device as claimed in claim 8, wherein the color filter comprises a black matrix, and the blocking is disposed corresponding to the black matrix.

11. The display device as claimed in claim 1, wherein the display medium is liquid crystal or polymer gel.

12. The display device as claimed in claim 1, wherein the blocking is disposed perpendicular to the gravitational direction when the display device is in operation.

13. A fabrication method of a display device, comprising:
providing a pair of substrates respectively with a counter electrode thereon;
disposing a seal pattern on the periphery of at least one substrate to surround a display area;
disposing a blocking on at least one substrate; and
joining the substrates with a gap formed therebetween by the seal pattern, and disposing a display medium between the substrates,
wherein the blocking separates the display area into at least two sub-display areas, each with the display medium thereon.

14. The fabrication method as claimed in claim 13, wherein the blocking comprises a sealing material for joining the substrates.

15. The fabrication method as claimed in claim 13, wherein the blocking comprises a spacer or photospacer.

16. The fabrication method as claimed in claim 13, wherein the seal pattern comprises a UV curable resin.

17. The fabrication method as claimed in claim 13, wherein the seal pattern comprises a spacer.

18. The fabrication method as claimed in claim 13, wherein the blocking and the seal pattern are of the same sealing material for joining the substrates.

19. The fabrication method as claimed in claim 13, wherein the substrates are glass or polymeric substrates.

20. The fabrication method as claimed in claim 13, wherein a color filter and an active matrix array are formed on the substrates.

21. The fabrication method as claimed in claim 20, further comprising:
forming a plurality of gate lines and signal lines in the active matrix, and
disposing the blocking corresponding to the gate lines or the signal lines.

22. The fabrication method as claimed in claim 20, wherein the color filter comprises a black matrix, and the blocking is disposed corresponding to the black matrix.

23. The fabrication method as claimed in claim 13, wherein the display medium is liquid crystal or polymer gel.

24. The fabrication method as claimed in claim 13, wherein the blocking is disposed perpendicular to the gravitational direction when the display device is in operation.
